(19) United States
(12) Patent Application Publication
(10) Pub. No.: US 2018/0041082 A1
(43) Pub. Date: Feb. 8, 2018

(54) WINDING ASSEMBLY FOR ROTARY ELECTRIC MACHINE AND METHOD OF MANUFACTURING

(71) Applicant: OTIS ELEVATOR COMPANY, Farmington, CT (US)

(72) Inventors: Zbigniew Piech, Cheshire, CT (US); Benjamin J. Watson, Collinsville, CT (US)

(21) Appl. No.: 15/228,306

(22) Filed: Aug. 4, 2016

(51) Int. Cl. H02K 3/12; H02K 15/06

(52) U.S. Cl. CPC H02K 3/12; H02K 15/064

(57) ABSTRACT

A winding assembly for a rotary electric machine includes a stator. Also included is a plurality of radially extending teeth defining a plurality of slots therebetween. Further included is a winding segment disposed within each of the slots, the winding segment having a constant cross-sectional area along an entire length thereof and a cross-sectional geometric shape that varies at each turn along a height of the teeth.

### BACKGROUND

The embodiments herein relate to winding assemblies and methods of manufacturing such assemblies.

High power, low voltage motors, such as those used in battery powered applications, require motors designed with a low number of turns per coil.

### BRIEF DESCRIPTION

According to one embodiment, a winding assembly for a rotary electric machine includes a stator. Also included is a plurality of radially extending teeth defining a plurality of slots therebetween. Further included is a winding segment disposed within each of the slots, the winding segment having a constant cross-sectional area along an entire length thereof and a cross-sectional geometric shape that varies at each turn along a height of the teeth.

In addition to one or more of the features described above, or as an alternative, further embodiments may include that the winding segment comprises a rectangular cross-sectional geometric shape.

In addition to one or more of the features described above, or as an alternative, further embodiments may include that the winding segment comprises a trapezoidal cross-sectional geometric shape.

In addition to one or more of the features described above, or as an alternative, further embodiments may include that the winding segment comprises a combination of trapezoidal and rectangular cross-sectional geometric shape portions.

In addition to one or more of the features described above, or as an alternative, further embodiments may include that the winding segment comprises a wire surrounded by an insulating layer, the wire comprising copper.

In addition to one or more of the features described above, or as an alternative, further embodiments may include that the winding segment comprises a wire surrounded by an insulating layer, the wire comprising aluminum.

In addition to one or more of the features described above, or as an alternative, further embodiments may include that the insulating layer is enameled to the wire.

In addition to one or more of the features described above, or as an alternative, further embodiments may include that the insulating layer is oxidized to the wire.

In addition to one or more of the features described above, or as an alternative, further embodiments may include that the rotary electric machine is a battery powered motor.

According to another embodiment, a method of manufacturing motor windings includes drawing a wire through a plurality of dies, the plurality of dies varying in at least two dimensions to form the wire to be of a constant cross-sectional area along an entire length thereof and a varying cross-sectional geometric shape.

In addition to one or more of the features described above, or as an alternative, further embodiments may include that the plurality of dies have a constant width and a decreasing height as measured in a plane orthogonal to the direction of travel of the wire being drawn through the dies.

In addition to one or more of the features described above, or as an alternative, further embodiments may include reversing the direction of travel of the wire to eject the wire from the dies.

In addition to one or more of the features described above, or as an alternative, further embodiments may include insulating the wire by enameling the wire that is formed of copper.

In addition to one or more of the features described above, or as an alternative, further embodiments may include insulating the wire by oxidizing the wire that is formed of aluminum.

In addition to one or more of the features described above, or as an alternative, further embodiments may include winding the motor winding around a plurality of teeth of a stator to dispose the motor winding within a slot of the stator until a final half turn of the motor winding is required. Also included is simultaneously energizing the motor winding and tensioning the motor winding prior to winding the motor winding the final half turn.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a sectional view of a motor winding according to an embodiment of the disclosure;

FIG. 2 is a sectional view of the motor winding according to another embodiment of the disclosure; and

FIG. 3 is a schematic illustration of a method of manufacturing the motor winding.

### DETAILED DESCRIPTION

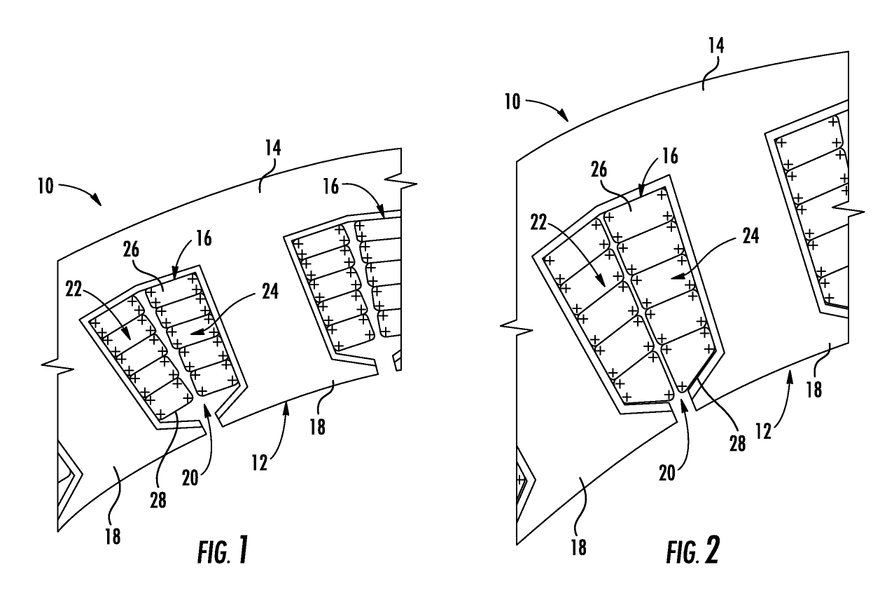

Referring to FIG. 1, a portion of a rotary electric machine, such as a motor 10, is illustrated. The embodiments described herein may benefit numerous types of rotary electric machines. In some embodiments, the machine is a battery driven motor, with a low number of turns per coil, high power and low voltage. This type of motor has challenges with conventional manufacturing methods which result in high noise and/or low efficiency. One problem driving this issue is that most motor slots are inherently trapezoidal and most conductors are either circular or rectangular, for example. Therefore, the result is a low motor slot fill where much of the slot area is unused.

The motor 10 includes a stator assembly 12 made up of a stator 14 and a plurality of windings generally designated with numeral 16. The stator 14 includes a plurality of teeth 18 and a plurality of slots 20 defined between respectively adjacent teeth 18. In the illustrated embodiment, each of the plurality of slots 20 includes a pair of winding segments 22, 24. The winding segments 22, 24 are positioned side-by-side within the slot 20 and each represents an electrical conductor. Various contemplated electrically conductive materials may be used to form wires of the winding segments 22, 24. For example, copper and aluminum may be employed, but it is to be appreciated that these examples are not limiting.

The winding segments 22, 24 each include an electrically insulating layer which serves to insulate the wires of the segments 22, 24 from one another while minimizing the non-electrically conducting fill within the cross-section of each slot 20. For copper wire, the conductors are enameled. In the case of aluminum wire, the conductors may be enameled or oxidized. Optionally, the aluminum wire may be coated in copper to improve its conductivity, which is done prior to enameling.

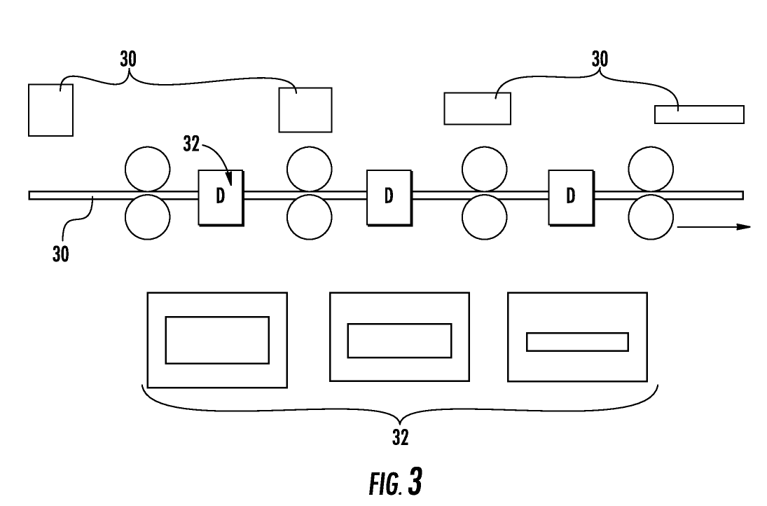

The winding segments 22, 24 are sized such that when positioned within the slot 20, completely all or substantially all of the cross-section of the slot 20 (i.e., in the plane shown in FIGS. 1 and 2) is filled. By increasing the extent to which the slots 20 are filled with the winding segments 22, 24, a closed slot assembly is achieved, which increases motor efficiency due to motor resistance and winding losses being reduced. Additionally, such a construction provides the option of using aluminum conductors to reduce cost. Generally, aluminum wire is not practical for motor winding because of its inherently lower conductivity. Greater conductor area, however, can offset this and allow the use of such a conductor material.

Typical stator slot and winding cross-sectional shapes are not conducive to obtaining a high slot fill. This is due to the slot being trapezoidal, for example, while windings are circular or rectangular, thereby resulting in much of the slot are being unused. The embodiments of the winding segments 22, 24 described herein are of constant cross-sectional area along an entire length thereof, but the cross-sectional geometric shape varies to better conform to the shape of the slot 20. The term “constant” used herein refers to the winding segments 22, 24 having a constant cross-sectional area such as within manufacturing tolerances as known to those of skill in the arts of at least metal extrusion and/or pultrusion processes, for example.

Various cross-sectional shapes of the winding segments 22, 24 may be employed depending upon the particular application. In the illustrated embodiments, a rectangular cross-section (FIG. 1) and a trapezoidal cross-section (FIG. 2) are utilized. It is further contemplated that a combination of geometric shape segments may be employed. For example, a combination of rectangular and trapezoidal segments may be employed. Furthermore, any combination of rectangular, trapezoidal, circular and/or square segments may be utilized in some embodiments.

Regardless of the specific geometry, the cross-sectional area remains constant, but the shape changes to accommodate the contour of the surfaces that define the slot 20 at different locations. As shown, in the illustrated trapezoidal slots, a wider winding segment is desirable proximate a first end 26 of the slot 20, while a narrower winding segment is desirable proximate a second end 28 of the slot 20. In particular, winding segment varies in portions along a length thereof. Each portion of the winding with a common cross-sectional geometric shape corresponds to a full turn of the winding around each tooth 18. Therefore, the shape is the same at the same height on each side of the tooth 18. As the winding is wound around the tooth 18, the shape varies when going up or down (i.e., toward or away from the ends 26, 28 of the slot 20). The varying shape of the winding segments 22, 24 accommodate the slot geometry to obtain a high fill with little or no wasted space within the slot 20. In some embodiments, the winding undergoes a number of full turns around the tooth ranging from 3 to 10. In such embodiments, the winding contains 3 to 10 winding segment portions with different geometric shapes, but with constant cross-sectional area.

Referring now to FIG. 3, a method of forming the winding segments 22, 24 is schematically represented. As shown, a wire 30 is drawn through a series of dies 32 to create the variable cross-sectional shape while maintaining the constant cross-sectional area that was described above. The length of each turn of the winding segments 22, 24 is controlled by selective spacing of the dies 32. A constant cross-sectional area is ensured by maintaining a constant linear speed along the length of the line. After a sufficient length of the wire 30 is drawn through, the line is reversed to eject the wire to preserve the varied shape. To facilitate reversal, the dies 32 have a constant width and decreasing height as measured in a plane orthogonal to the direction of travel of the wire being drawn through the dies, with the width of the wire 30 being less than the width of the dies 32. Once the wire 30 is ejected from the dies 32, it is insulated in the manner described in detail above.

The winding segments 22, 24 are then wound onto the teeth 18 in a typical manner to dispose them in the slots 20. Prior to winding the final half turn, the winding segment is simultaneously energized and tensioned. Energizing the coil heats the metal to make it softer. When the winding segment is tensioned, the conductor pulls tight against the tooth 18. This improves the heat transfer between the coil and the tooth and improves the slot fill. Optionally, if self-bonding insulation is employed, this operation can solidify the tooth/coil assembly.

Advantageously, higher motor slot fill is achieved. This translates into better motor efficiency, motor cost reduction, or a combination of these two advantages.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A winding assembly for a rotary electric machine comprising:
a stator;
a plurality of radially extending teeth defining a plurality of slots therebetween; and
a winding segment disposed within each of the slots, the winding segment having a constant cross-sectional area along an entire length thereof and a cross-sectional geometric shape that varies at each turn along a height of the teeth.

2. The winding assembly of claim 1, wherein the winding segment comprises a rectangular cross-sectional geometric shape.

3. The winding assembly of claim 1, wherein the winding segment comprises a trapezoidal cross-sectional geometric shape.

4. The winding assembly of claim 1, wherein the winding segment comprises a combination of trapezoidal and rectangular cross-sectional geometric shape portions.

5. The winding assembly of any of the preceding claims, wherein the winding segment comprises a wire surrounded by an insulating layer, the wire comprising copper.

6. The winding assembly of any of claims 1-4, wherein the winding segment comprises a wire surrounded by an insulating layer, the wire comprising aluminum.

7. The winding assembly of claim 5 or 6, wherein the insulating layer is enameled to the wire.

8. The winding assembly of claim 5 or 6, wherein the insulating layer is oxidized to the wire.

9. The winding assembly of any of the preceding claims, wherein the rotary electric machine is a battery powered motor.

10. A method of manufacturing motor windings comprising drawing a wire through a plurality of dies, the plurality of dies varying in at least two dimensions to form the wire to be of a constant cross-sectional area along an entire length thereof and a varying cross-sectional geometric shape.

11. The method of claim 10, wherein the plurality of dies have a constant width and a decreasing height as measured in a plane orthogonal to the direction of travel of the wire being drawn through the dies.

12. The method of claim 10 or 11, further comprising reversing the direction of travel of the wire to eject the wire from the dies.

13. The method of any of claims 10-12, further comprising insulating the wire by enameling the wire that is formed of copper.

14. The method of any of claims 10-12, further comprising insulating the wire by oxidizing the wire that is formed of aluminum.

15. The method of any of claims 10-14, further comprising:
winding the motor winding around a plurality of teeth of a stator to dispose the motor winding within a slot of the stator until a final half turn of the motor winding is required; and
simultaneously energizing the motor winding and tensioning the motor winding prior to winding the motor winding the final half turn.
